(19) United States
(12) Patent Application Publication
(10) Pub. No.: US 2026/0346625 A1
(43) Pub. Date: Nov. 5, 2026

(54) MEDIUM CONVEYANCE APPARATUS, PRINTING APPARATUS, AND MEDIUM CONVEYANCE METHOD

(71) Applicant: SEIKO EPSON CORPORATION, Tokyo (JP)

(72) Inventors: Riku MAEDA, SHIOJIRI-SHI (JP); Yuki HARA, SHIOJIRI-SHI (JP)

(21) Appl. No.: 19/556,246

(22) Filed: Mar. 4, 2026

(30) Foreign Application Priority Data
Mar. 7, 2025 (JP) 2025-036606

(51) Int. Cl. B41J 13/00; B41J 11/00; B41J 13/10

(52) U.S. Cl. CPC B41J 13/0018; B41J 11/0095; B41J 13/103; B41J 13/106

(57) ABSTRACT

According to an aspect of the present disclosure, there is provided a medium conveyance apparatus including a conveyance unit configured to convey media, a detection unit configured to detect the media conveyed by the conveyance unit, and a control unit configured to determine the presence or absence of double feed of the media based on a threshold and a detection result of the detection unit and control driving of the conveyance unit, in which the control unit updates the threshold based on the detection result and sets conveyance speed of the media during a conveyance operation in updating the threshold to be lower than conveyance speed of the media during a conveyance operation in not updating the threshold.

The present application is based on, and claims priority from JP Application Serial Number 2025-036606, filed Mar. 7, 2025, the disclosure of which is hereby incorporated by reference herein in its entirety.

### BACKGROUND

### 1. Technical Field

The present disclosure relates to a medium conveyance apparatus, a printing apparatus, and a medium conveyance method.

### 2. Related Art

Various medium conveyance apparatuses that convey media, such as an inkjet printer and a scanner, have been used. Among these medium conveyance apparatuses, there is a medium conveyance apparatus including a detection unit that detects a conveyed medium. For example, JP-A-2008-290810 and JP-A-2017-39591 disclose an image forming apparatus that detects double feed in which a plurality of conveyed media are conveyed in a stacked state.

JP-A-2008-290810 and JP-A-2017-39591 are examples of the related art.

The image forming apparatus disclosed in JP-A-2008-290810 sequentially updates a threshold of double feed determination based on information concerning the immediately preceding medium that is continuously conveyed. However, it is likely that the configuration explained above causes deterioration in productivity or deterioration in accuracy of the double feed determination. This is because it is likely that, when the threshold of the double feed determination is set based on media conveyed at high speed, the threshold is not properly set because the media are not stably conveyed and productivity is deteriorated when the media are conveyed at low speed. The image forming apparatus disclosed in JP-A-2017-39591 updates the threshold by performing, between continuously conveyed media, calibration without media in the same print job. However, variation due to types of media cannot be corrected because the calibration without media is performed. As explained above, in the medium conveyance apparatus of the related art, it is difficult to highly accurately determine the presence or absence of double feed of the media while suppressing deterioration in productivity.

### SUMMARY

According to an aspect of the present disclosure, there is provided a medium conveyance apparatus including: a conveyance unit configured to convey media; a detection unit configured to detect the media conveyed by the conveyance unit; and a control unit configured to determine presence or absence of double feed of the media based on a threshold and a detection result of the detection unit and control driving of the conveyance unit, in which the control unit updates the threshold based on the detection result and sets conveyance speed of the media during a conveyance operation in updating the threshold to be lower than conveyance speed of the media during a conveyance operation in not updating the threshold.

According to another aspect of the present disclosure, there is provided a medium conveyance method in a medium conveyance apparatus including: a conveyance unit configured to convey media; and a detection unit configured to detect the media conveyed by the conveyance unit, the medium conveyance apparatus determining presence or absence of double feed of the media based on a threshold and a detection result of the detection unit, the medium conveyance method including: updating the threshold based on the detection result; and setting conveyance speed of the media during a conveyance operation in updating the threshold to be lower than conveyance speed of the media during a conveyance operation in not updating the threshold.

### BRIEF DESCRIPTION OF THE DRAWINGS

FIG. 1 is a schematic diagram illustrating a printing apparatus serving as a medium conveyance apparatus according to an embodiment of the present disclosure.

FIG. 2 is a schematic diagram illustrating a state in which a first medium conveyed in the printing apparatus illustrated in FIG. 1 is detected by a detection unit.

FIG. 3 is a schematic diagram illustrating a state in which a second medium conveyed in the printing apparatus illustrated in FIG. 1 is detected by the detection unit.

FIG. 4 is a schematic diagram illustrating a state in which an n-th medium conveyed in the printing apparatus illustrated in FIG. 1 is detected by the detection unit.

FIG. 5 is a schematic diagram illustrating a state in which an n+1-th medium conveyed in the printing apparatus illustrated in FIG. 1 is detected by the detection unit.

FIG. 6 is a flowchart illustrating an example of a medium conveyance method that can be executed in the printing apparatus illustrated in FIG. 1.

FIG. 7 is a schematic diagram illustrating a state in which different two types of media are conveyed in the printing apparatus illustrated in FIG. 1.

### DESCRIPTION OF EMBODIMENTS

The present disclosure is schematically explained below.

According to a first aspect of the present disclosure, there is provided a medium conveyance apparatus including: a conveyance unit configured to convey media; a detection unit configured to detect the media conveyed by the conveyance unit; and a control unit configured to determine presence or absence of double feed of the media based on a threshold and a detection result of the detection unit and control driving of the conveyance unit, in which the control unit updates the threshold based on the detection result and sets conveyance speed of the media during a conveyance operation in updating the threshold to be lower than conveyance speed of the media during a conveyance operation in not updating the threshold.

According to this aspect, it is possible to update, based on the detection result for the media, the threshold for determining the presence or absence of double feed of the media. By updating the threshold, for example, it is possible to increase the accuracy of the double feed determination for second and subsequent media or to increase the accuracy of the double feed determination for a first medium based on the last medium conveyance result. Since the threshold is updated based on the detection result for the media, it is also possible to correct variation due to types of media. Further, it is possible to particularly suitably set the threshold by reducing the conveyance speed of the media during the conveyance operation in updating the threshold, it is possible to maintain, at high speed, the conveyance speed of the media during the conveyance operation in not updating the threshold, and it is possible to suppress deterioration in productivity. Therefore, it is possible to highly accurately determine the presence or absence of double feed of the media while suppressing deterioration in productivity.

A medium conveyance apparatus according to a second aspect of the present disclosure is an aspect dependent from the first aspect, in which the control unit updates the threshold during the conveyance operation in continuously conveying the media.

According to this aspect, it is possible to update the threshold during the conveyance operation in continuously conveying the media. With the configuration explained above, it is possible to update the threshold without stopping the conveyance of the media, for example, while maintaining the conveyance speed of the media and it is possible to suppress deterioration in productivity.

A medium conveyance apparatus according to a third aspect of the present disclosure is an aspect dependent from the first or second aspect, further including: a placement unit on which the media are placed; and a feeding port through which the media placed on the placement unit are fed, in which the conveyance unit is configured to feed the media from the feeding port, and the detection unit is disposed at a position where the detection unit detects the media fed from the feeding port.

According to this aspect, the detection unit is disposed at the position where the detection unit can detect the media fed from the feeding port. With the configuration explained above, it is possible to set the threshold based on a detection result near the feeding port.

A medium conveyance apparatus according to a fourth aspect of the present disclosure is an aspect dependent from the third aspect, in which the medium conveyance apparatus includes a plurality of the placement units, and the control unit continuously conveys the media from the placement units different from one another in random order.

According to this aspect, it is possible to include the plurality of placement units and continuously convey the media from the different placement units in random order. With the configuration explained above, for example, it is possible to convey, together with print media, for example, media different from the print media corresponding to pages, such as media for a cover or media for an interleaf used for bookbinding or the like.

A medium conveyance apparatus according to a fifth aspect of the present disclosure is an aspect dependent from the fourth aspect, in which the control unit updates the threshold to correspond to the respective placement units.

According to this aspect, it is possible to update the threshold to correspond to the respective placement units. With the configuration explained above, for example, it is possible to suitably convey, together with the print media, for example, media other than print media corresponding to pages, such as mediums for a cover or media for an interleaf used for bookbinding or the like.

A medium conveyance apparatus according to a sixth aspect of the present disclosure is an aspect dependent from any one of the first to fifth aspects, further including a selection unit configured to select in which of the conveyed media the threshold is updated.

According to this aspect, the medium conveyance apparatus includes the selection unit that selects in which of the conveyed media the threshold is updated. By selecting in which of the conveyed media the threshold is updated, a user can suitably select and set whether to convey the media by placing emphasis on suppression of deterioration in productivity or to convey the media by particularly highly accurately determining the presence or absence of double feed of the media.

According to a seventh aspect of the present disclosure, there is provided a printing apparatus including: the medium conveyance apparatus according to any one of the first to sixth aspects; and a printing unit configured to perform printing on the media conveyed by the conveyance unit.

According to this aspect, the printing apparatus includes the medium conveyance apparatus explained above and the printing unit that performs printing on the media conveyed by the conveyance unit. For this reason, it is possible to suitably perform printing on the media with high productivity after highly accurately determining the presence or absence of double feed of the media.

A printing apparatus according to an eighth aspect of the present disclosure is an aspect dependent from the seventh aspect, in which, when printing is performed on only one print medium among the media, the control unit causes the conveyance unit to convey a medium for threshold update different from the print medium among the media before the printing and updates the threshold.

According to this aspect, when printing is performed on only one print medium, the threshold is updated by causing the conveyance unit to convey the medium for threshold update before the printing. With the configuration explained above, it is possible to suitably perform printing on the print medium after highly accurately determining the presence or absence of double feed of the print media at the time when printing is performed on only one print medium.

A printing apparatus according to a ninth aspect of the present disclosure is an aspect dependent from the eighth aspect, further including a discharge unit to which the media are discharged, in which the printing apparatus includes, as the discharge unit, a first discharge unit to which the print medium is discharged and a second discharge unit to which the medium for threshold update is discharged.

According to this aspect, the printing apparatus includes, as the discharge unit, the first discharge unit to which the print medium is discharged and the second discharge unit to which the medium for threshold update is discharged. With the configuration explained above, it is possible to prevent the medium for threshold update from being mixed with the print medium.

According to a tenth aspect of the present disclosure, there is provided a medium conveyance method in a medium conveyance apparatus including: a conveyance unit configured to convey media; and a detection unit configured to detect the media conveyed by the conveyance unit, the medium conveyance apparatus determining presence or absence of double feed of the media based on a threshold and a detection result of the detection unit, the medium conveyance method including: updating the threshold based on the detection result; and setting conveyance speed of the media during a conveyance operation in updating the threshold to be lower than conveyance speed of the media during a conveyance operation in not updating the threshold.

According to this aspect, it is possible to update, based on the detection result for the media, the threshold for determining the presence or absence of double feed of the media. By updating the threshold, for example, it is possible to increase the accuracy of the double feed determination for second and subsequent media or to increase the accuracy of the double feed determination for a first medium based on the last medium conveyance result. Since the threshold is updated based on the detection result for the media, it is also possible to correct variation due to types of media. Further, it is possible to particularly suitably set the threshold by reducing the conveyance speed of the media during the conveyance operation in updating the threshold, it is possible to maintain, at high speed, the conveyance speed of the media during the conveyance operation in not updating the threshold, and it is possible to suppress deterioration in productivity. Therefore, it is possible to highly accurately determine the presence or absence of double feed of the media while suppressing deterioration in productivity.

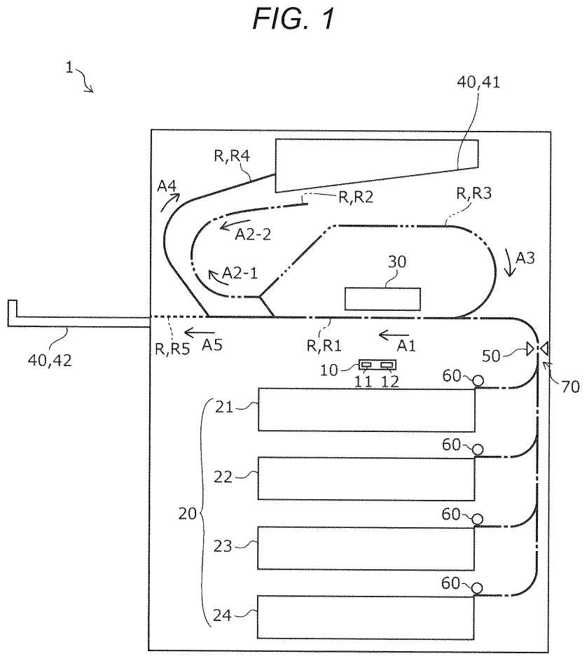

Hereinafter, a printing apparatus 1, which is an example of a medium conveyance apparatus according to an embodiment of the present disclosure, is explained with reference to FIGS. 1 to 7. First, an overview of the printing apparatus 1 in the present embodiment is explained.

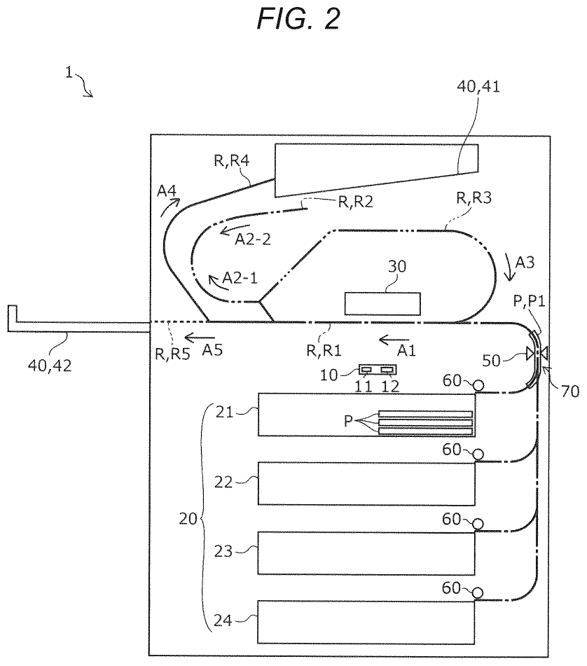

As illustrated in FIG. 1 and the like, the printing apparatus 1 in the present embodiment includes a placement unit 20 on which media P illustrated in FIG. 2 and the like are placed, a conveyance path R for the media P, conveyance units 60 that convey the media P, a printing unit 30 that performs printing on the media P conveyed by the conveyance units 60, and a discharge unit 40 to which the media P are discharged. Further, as illustrated in FIG. 1 and the like, the printing apparatus 1 in the present embodiment includes a feeding port 70 through which the media P placed on the placement unit 20 is fed, a detection unit 50 provided at a position where the detection unit 50 can detect the medium P fed from the feeding port 70, and a control unit 10 that controls overall driving of the constituent members of the printing apparatus 1.

As illustrated in FIG. 1 and the like, the printing apparatus 1 in the present embodiment includes a first placement unit 21, a second placement unit 22, a third placement unit 23, and a fourth placement unit 24 as the placement unit 20. For this reason, the printing apparatus 1 in the present embodiment can store different types of media P or media P having different sizes in the respective placement units 20.

As illustrated in FIG. 1 and the like, the printing apparatus 1 of the present embodiment includes a first discharge unit 41 and a second discharge unit 42 as the discharge unit 40. For this reason, the printing apparatus 1 in the present embodiment can discharge different types of media P, media P having different sizes, and the like separately to the first discharge unit 41 and the second discharge unit 42.

The conveyance path R for the media P is a conveyance path for the media P conveyed from the placement unit 20 to the discharge unit 40. As illustrated in FIG. 1 and the like, the printing apparatus 1 in the present embodiment includes, as the conveyance path R, a feed path R1 represented by an alternate long and short dash line, a switchback path R2 connected to the feed path R1 and represented by an alternate long and two short dashes line, a reverse path R3 connecting the switchback path R2 to the feed path R1 and represented by an alternate long and three short dashes line, a first discharge path R4 connecting the feed path R1 to the first discharge unit 41 and represented by a solid line, and a second discharge path R5 connecting the feed path R1 to the second discharge unit 42 and represented by a broken line. The medium P is conveyed in a conveyance direction A1 in the feed path R1, the medium P is conveyed in a conveyance direction A2-2 after being conveyed in a conveyance direction A2-1 in the switchback path R2, the medium P is conveyed in a conveyance direction A3 in the reverse path R3, the medium P is conveyed in a conveyance direction A4 in the first discharge path R4, and the medium P is conveyed in a conveyance direction A5 in the second discharge path R5.

Here, in FIG. 1 and the like, only representative conveyance units 60 are illustrated. However, actually, the conveyance units 60 are provided in all of the feeding path R1, the switchback path R2, the reverse path R3, the first discharge path R4, and the second discharge path R5. A configuration and the number of the conveyance units 60 are not particularly limited. One or a plurality of roller pairs, conveyor belts, and the like can be provided according to necessity.

The printing unit 30 is provided in the feeding path R1. The printing unit 30 can also perform printing on a second surface of the medium P opposite to a first surface of the medium P by conveying, through the switchback path R2 and the reverse path R3, the medium P that has been conveyed through the feeding path R1 and on the first surface of which printing has been performed and reversing the medium P. With the configuration explained above, for example, it is also possible to discharge the medium P only on the first surface of which printing has been performed to the first discharge unit 41 via the first discharge path R4 and discharge the medium P on both of the first surface and the second surface of which printing has been performed to the second discharge unit 42 via the second discharge path R5.

The printing unit 30 in the present embodiment is a so-called line head in which nozzles that discharge ink are provided to cover the entire medium width direction and is configured as a printing head capable of performing printing in the entire width direction of the medium P without involving movement of the medium P in the width direction. However, in the case of the printing unit 30 that performs recording by ejecting liquid such as ink onto the medium P, the printing unit 30 is not limited to the line head. The printing unit 30 may be a so-called serial head that performs printing while reciprocating in the width direction of the medium P. Furthermore, the printing apparatus 1 may include the printing unit 30 that performs printing using toner instead of the printing unit 30 that discharges the liquid ink.

Further, as illustrated in FIG. 1 and the like, in the printing apparatus 1 in the present embodiment, the detection unit 50 is provided near the feeding port 70 provided in the feed path R1. As the detection unit 50, for example, an optical sensor and an ultrasonic sensor can be used. The detection unit 50 can not only detect the presence or absence of the media P but also detect double feed of the media P. When the optical sensor is used as the detection unit 50, for example, it is possible to detect not only the presence or absence of the media P but also overlap of the media P from the reflection intensity of light emitted from a light emitting unit. Further, a transmissive optical sensor can also be used. When the ultrasonic sensor is used as the detection unit 50, it is possible to detect not only the presence or absence of the media P but also the overlap of the media P from attenuation of the amplitude of an ultrasonic wave transmitted from an ultrasonic transmission unit.

As explained above, the printing apparatus 1 in the present embodiment serving as the medium conveyance apparatus includes the conveyance units 60 that convey the media P and the detection unit 50 that detects the media P conveyed by the conveyance units 60. Here, the control unit 10 includes a CPU 11 and a storage unit 12 including a ROM and a RAM. In the storage unit 12, various control programs, data, and the like are stored and data of a threshold used for double feed determination is also stored. That is, the control unit 10 can determine the presence or absence of double feed of the media P based on the threshold stored in the storage unit 12 and a detection result of the detection unit 50 and control driving of the conveyance units 60.

Further, the control unit 10 can update the threshold based on the detection result of the detection unit 50. The control unit 10 may overwrite a threshold originally stored in the storage unit 12 or may cause the storage unit 12 to store a new threshold separately from the threshold originally stored in the storage unit 12. By updating the threshold, it is possible to cope with a change in an optimum threshold involved in a temporal change. The control unit 10 can set conveyance speed of the media P during a conveyance operation in not updating the threshold to be lower than conveyance speed of the media P during a conveyance operation in updating the threshold.

By updating the threshold, for example, it is possible to increase the accuracy of double feed determination in second and subsequent media P among the continuously conveyed media P or to increase the accuracy of double feed determination for a first medium P based on the last conveyance result of the media P. Since the threshold is updated based on the detection result for the media P, it is also possible to correct variation due to types of the media P. Further, since it is possible to increase conveyance stability of the media P by reducing the conveyance speed of the media P during the conveyance operation, it is possible to particularly suitably set the threshold by reducing the conveyance speed of the media P during the conveyance operation in updating the threshold and it is possible to maintain, at high speed, the conveyance speed of the media P during the conveyance operation in not updating the threshold. It is possible to suppress deterioration in productivity. Therefore, the printing apparatus 1 in the present embodiment can highly accurately determine the presence or absence of double feed of the media P while suppressing deterioration in productivity.

Here, from the viewpoint of the printing apparatus, the printing apparatus 1 in the present embodiment includes the medium conveyance apparatus explained above and the printing unit 30 that performs printing on the media P conveyed by the conveyance units 60. Therefore, the printing apparatus 1 in the present embodiment can suitably perform printing on the media P with high productivity after highly accurately determining the presence or absence of double feed of the media P.

Hereinafter, an example of a medium conveyance method (a double feed detection method) in the printing apparatus 1 in the present embodiment is specifically explained with reference to FIGS. 2 to 7. Here, the control unit 10 of the printing apparatus 1 in the present embodiment can receive various instructions input via a not-illustrated external computer, a not-illustrated operation panel, or the like and control driving of the constituent members of the printing apparatus 1. For example, the control unit 10 can receive, via the not-illustrated external computer, the not-illustrated operation panel, or the like, an instruction as to in which of the conveyed media P the threshold is updated and control driving of the conveyance units 60 and the detection unit 50.

In other words, together with the not-illustrated operation panel or the like, the control unit 10 of the printing apparatus 1 in the present embodiment also plays a role of a selection unit that selects in which of the conveyed media P the threshold is updated. As explained above, the printing apparatus 1 in to the present embodiment includes the selection unit that selects in which of the conveyed media P the threshold is updated. By selecting in which of the conveyed media P the threshold is updated, the user can suitably select and set, for example, whether to convey the media P by extending update timing for the threshold and placing emphasis on suppression of deterioration in productivity or whether to convey the media P by shortening update timing for the threshold and particularly highly accurately determining the presence or absence of double feed of the media P.

Here, FIG. 2 illustrates a state in which a medium P1, which is the first medium P conveyed in the printing apparatus 1 in the present embodiment, is detected by the detection unit 50. For example, the printing apparatus 1 in the present embodiment can select to update the threshold in the medium P1 conveyed first. In this case, the threshold used for the double feed determination can be, for example, a threshold stored in the storage unit 12. In the storage unit 12, for example, a table of thresholds set in advance according to types of the media P or the like can be stored in advance. When performing the double feed determination in the medium P1 conveyed first, the printing apparatus 1 in the present embodiment can perform the double feed determination based on the threshold and the detection result for the medium P1 by the detection unit 50.

When updating the threshold in the medium P conveyed first, in conveying the first medium P1, the printing apparatus 1 sets conveyance speed lower than normal speed, which is conveyance speed when not updating the threshold in the medium P1 conveyed first. Then, an n-th (n is an integer of 2 or more) medium Pn conveyed second and subsequently is conveyed at the normal speed until the number of conveyed media for updating the threshold next is reached.

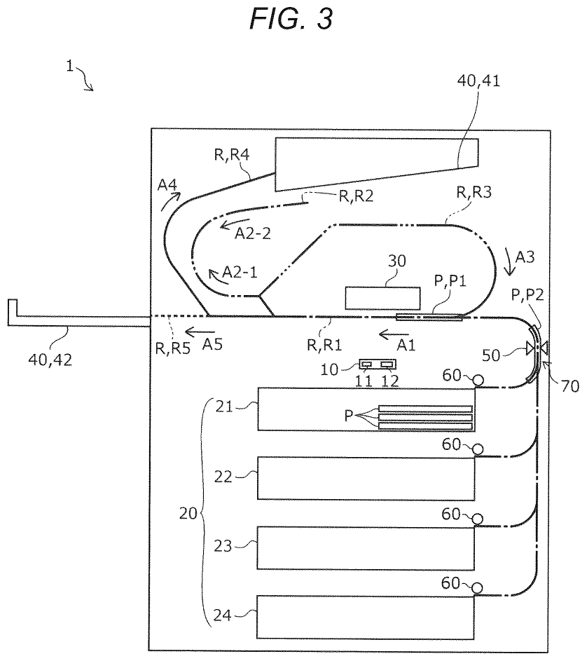

FIG. 3 illustrates a state in which the conveyance operation for the media P is continuously executed from the state of FIG. 2 and a medium P2, which is the second medium P conveyed in the printing apparatus 1 in the present embodiment, is detected by the detection unit 50. The printing apparatus 1 in the present embodiment can detect the conveyed medium P with the detection unit 50 every time regardless of whether the threshold is updated. By detecting the conveyed medium P with the detection unit 50 every time in this way, it is possible to not only detect the presence or absence of double feed of the medium P but also detect a jam of the medium P by detecting that the medium P is not detected at predetermined timing.

Here, for example, the printing apparatus 1 in the present embodiment can select to update the threshold in the medium P2 conveyed second. When the threshold is updated in the medium P1 conveyed first, the threshold used for the double feed determination in the medium P2 conveyed second can be set to the updated threshold. On the other hand, when the threshold is not updated in the medium P1 conveyed first, the threshold can be set to a threshold stored in the storage unit 12 in advance before the start of the conveyance operation. In performing the double feed determination in the medium P2 conveyed second, the printing apparatus 1 in the present embodiment can perform the double feed determination based on any one of the thresholds explained above and a detection result for the medium P2 by the detection unit 50. When the threshold is updated in both of the medium P1 and the medium P2, it is also possible to detect double feed, conveyance failure, or the like of the medium P1 when the threshold stored in the storage unit 12 in advance before the start of the conveyance operation and the threshold updated based on the medium P2 are greatly different from the threshold updated based on the medium P1.

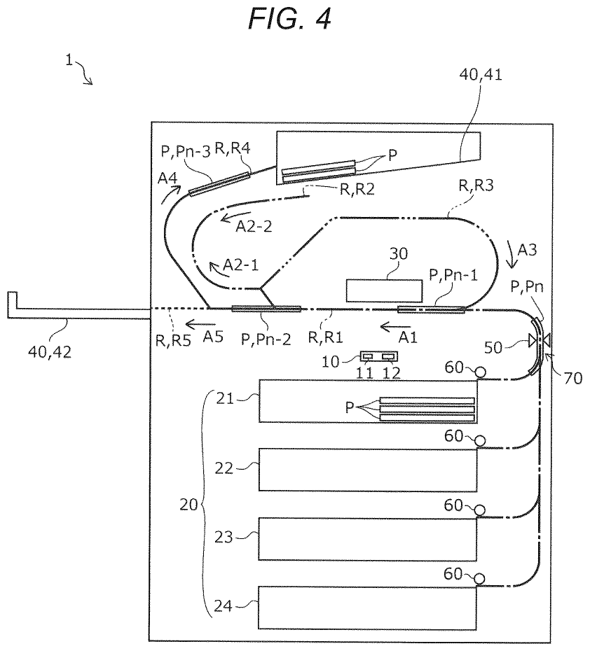

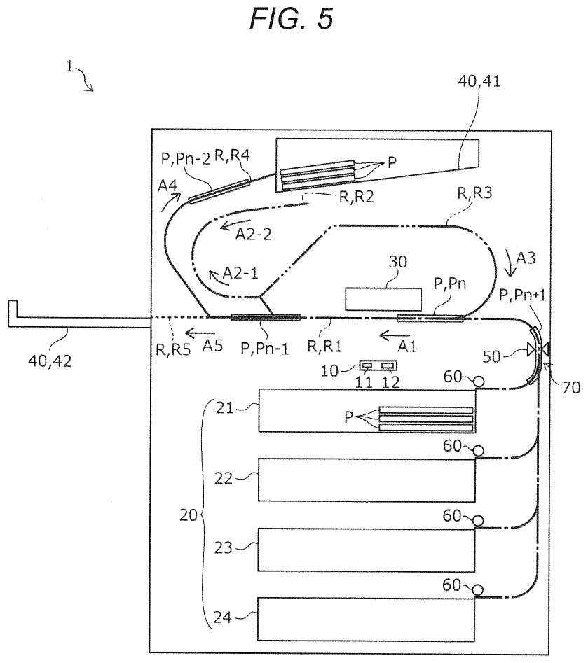

FIG. 4 illustrates a state in which the conveyance operation for the media P is continuously executed from the state illustrated in FIG. 3 and the medium Pn, which is the n-th (n is an integer of 2 or more) medium P conveyed in the printing apparatus 1 in the present embodiment, is detected by the detection unit 50. FIG. 5 illustrates a state in which the conveyance operation for the media P is continuously executed from the state illustrated in FIG. 4 and a medium Pn+1, which is an n+1-th medium P conveyed in the printing apparatus 1 in the present embodiment, is detected by the detection unit 50.

In the printing apparatus 1 in the present embodiment, the user can select, based on the conveyed media P, in which of the conveyed media P the threshold is updated. For example, concerning the conveyed media P, for example, the user can select whether to update the threshold in every medium (every time), every ten media, every one hundred media, or the like. For example, when it is selected to update the threshold in each medium, double feed determination is performed for the n-th medium Pn based on the threshold updated based on a detection result for the n−1-th medium Pn−1 and a detection result for the medium Pn. For example, when it is selected to update the threshold in every ten media, if the threshold is updated in an m-th medium (m is a multiple of 10), the double feed determination is performed for m+1-th to m+9-th media P based on the threshold, which is updated based on a detection result for the m-th medium P, and a detection result for each of the m+1-th to m+9-th media P. For example, when it is selected to update the threshold in every one hundred media, if the threshold is updated in a k-th medium (k is a multiple of 100), the double feed determination is performed for k+1-th to k+99-th media P based on the threshold, which is updated based on a detection result for the k-th medium P, and a detection result for each of the k+1-th to k+99-th media P. For example, by continuously updating the threshold in every ten media or every one hundred media, it is possible to cope with deviation of the threshold from an optimum value due to a temporal change.

Further, in the printing apparatus 1 in the present embodiment, the user can also select to update the threshold based on from which of, among the placement units 20, the first placement unit 21, the second placement unit 22, the third placement unit 23, and the fourth placement unit 24 the conveyed media P are conveyed being switched. When from which of a plurality of placement units 20 the media P are conveyed is switched, types of the media P or the like are often changed accordingly. For this reason, it is preferable to set the threshold to an optimal threshold according to the media P being conveyed from different placement units 20. The printing apparatus 1 in the present embodiment can suitably determine double feed even when from which of the plurality of placement units 20 the media P are conveyed is switched.

Here, in the printing apparatus 1 in the present embodiment, the control unit 10 is capable of updating the threshold during the conveyance operation in continuously conveying the media P. With the configuration explained above, it is possible to update the threshold without stopping the conveyance of the media P, for example, while maintaining the conveyance speed of the media P and it is possible to suppress deterioration in productivity.

As explained above, the printing apparatus 1 in the present embodiment includes the placement units 20 on which the media P are placed and the feeding port 70 through which the media P placed on the placement units 20 are fed. The conveyance units 60 are configured to be capable of feeding the media P from the feeding port 70. The detection unit 50 is disposed at a position where the detection unit 50 can detect the media P fed from the feeding port 70. With the configuration explained above, the threshold can be set based on a detection result near the feeding port 70. In the present embodiment, the feeding port 70 is regarded as a feeding port common to the first placement unit 21, the second placement unit 22, the third placement unit 23, and the fourth placement unit 24. However, an individual feeding port 70 may be provided near each of the first placement unit 21, the second placement unit 22, the third placement unit 23, and the fourth placement unit 24. The detection unit 50 may be individually provided near the feeding port 70.

In performing printing on only one medium P, before the printing, the printing apparatus 1 in the present embodiment can perform test conveyance for updating the threshold. In other words, in the printing apparatus 1 in the present embodiment, in performing printing on only one print medium among the media P, before the printing, the control unit 10 can cause the conveyance units 60 to convey a medium for threshold update different from the print medium among the media P to update the threshold. With the configuration explained above, it is possible to suitably perform printing on the print medium after highly accurately determining the presence or absence of double feed of the print media at the time when printing is performed on only one print medium. In the test conveyance, test printing in which printing is performed in addition to conveyance may be performed or only conveyance may be performed without printing being performed. It is preferable that the medium for threshold update used in the test conveyance is the medium P of the same type as the print medium.

As explained above, the printing apparatus 1 in the present embodiment includes the first discharge unit 41 and the second discharge unit 42 as the discharge unit 40 to which the media are discharged. The printing apparatus 1 in the present embodiment can discharge the print medium on which printing is performed to the first discharge unit 41 and discharge a medium for threshold update used in the test conveyance to the second discharge unit 42. As in the printing apparatus 1 in the present embodiment, it is preferable that the printing apparatus 1 includes, as the discharge unit 40, the first discharge unit 41 to which the print medium is discharged and the second discharge unit 42 to which the medium for threshold update is discharged. This is because, with the configuration explained above, it is possible to prevent the medium for threshold update from being mixed with the print medium. The printing apparatus 1 in the present embodiment can also discharge the print medium on which printing is performed to the second discharge unit 42 and discharge the medium for threshold update used in the test conveyance to the first discharge unit 41.

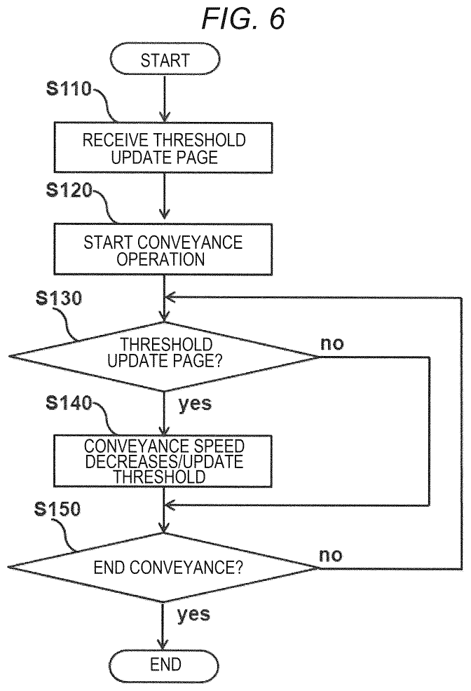

Here, an example of a medium conveyance method (a double feed detection method) in the printing apparatus 1 in the present embodiment serving as the medium conveyance apparatus including the conveyance units 60 that convey the media P and the detection unit 50 that detects the media P conveyed by the conveyance units 60 and capable of determining the presence or absence of double feed of the media P based on a threshold and a detection result of the detection unit 50 is explained with reference to FIG. 6. In the medium conveyance method illustrated in FIG. 6, first, an instruction for a threshold update page from the user is received in step S110. Specifically, the user inputs, via a not-illustrated external computer, a not-illustrated operation panel, or the like, in which of the conveyed media P the threshold is updated. Then, the control unit 10 receives the input instruction.

Subsequently, in step S120, a conveyance operation is started according to control of the control unit 10. Subsequently, in step S130, the conveyance operation is continued while determining at any time whether the threshold update page has reached a detection position of the detection unit 50. When it is determined that the threshold update page reaches the detection position of the detection unit 50, conveyance speed of the media P is reduced from the normal speed in step S140 immediately before the threshold update page reaches the detection position and, when the threshold update page has reached the detection position of the detection unit 50, the threshold is updated based on a detection result of the detection unit 50. Then, steps S130 to S150 are repeated until it is determined in step S150 to end the conveyance.

As explained above, in the medium conveyance method illustrated in FIG. 6, in step S140, the threshold can be updated based on the detection result for the media P by the detection unit 50. The conveyance speed of the media P during the conveyance operation in updating the threshold is set lower than the normal speed, which is the conveyance speed of the media P during the conveyance operation in not updating the threshold. By executing the medium conveyance method explained above, it is possible to highly accurately determine the presence or absence of double feed of the media P while suppressing deterioration in productivity.

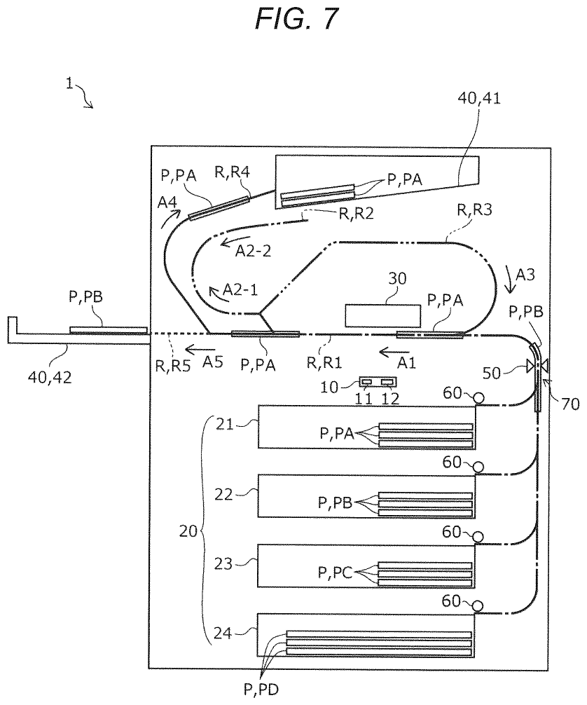

As explained above, the printing apparatus 1 in the present embodiment includes the first placement unit 21, the second placement unit 22, the third placement unit 23, and the fourth placement unit 24 as the placement unit 20, includes the first discharge unit 41 and the second discharge unit 42 as the discharge unit 40, and can discharge different types of media P or the like separately to the first discharge unit 41 and the second discharge unit 42 according to the control of the control unit 10. For example, as illustrated in FIG. 7, in order to form bookbinding or the like, media PA, which are the media P equivalent to pages, can be placed on the first placement unit 21, media PB, which are the media P equivalent to a cover, can be placed on the second placement unit 22, and the media PA can be discharged to the first discharge unit 41 and the media PB can be discharged to the second discharge unit 42. As illustrated in FIG. 7, in the printing apparatus 1 in the present embodiment, media PC for an interleaf, which is paper sandwiched between prints, such as colored paper, are placed on the third placement unit 23 and media PD having a large size are placed on the fourth placement unit 24, and, instead of the media PB, these media P can also be discharged to, for example, the discharge unit 40 different from the discharge unit 40 to which the media PA are discharged.

In other words, the printing apparatus 1 in the present embodiment includes the plurality of placement units 20 and the control unit 10 is capable of continuously conveying the media P from the placement units 20 different from one another in random order. With the configuration explained above, for example, it is also possible to convey, together with the print media, the media P (the media PB, the media PC, and the media PD) different from the print media (the media PA) corresponding to pages, such as the media PB for a cover or the media PC for an interleaf used for bookbinding or the like.

Here, in the printing apparatus 1 in the present embodiment, the control unit 10 is capable of updating the threshold to correspond to the respective placement units 20 (the first placement unit 21, the second placement unit 22, the third placement unit 23, and the fourth placement unit 24). With the configuration explained above, for example, it is also possible to suitably convey, together with the print media, the media P different from the print media (the media PA) corresponding to the pages, such as the media PB for the cover or the media PC for the interleaf used for bookbinding or the like.

The present disclosure is not limited to the embodiment and the modifications explained above and various modifications can be made within the scope of the disclosure set forth in the appended claims, and it is needless to say that these modifications also fall within the scope of the disclosure. For example, in the above explanation, the printing apparatus is explained as an example of the medium conveyance apparatus of the present disclosure. However, the medium conveyance apparatus of the present disclosure is not limited to the printing apparatus and may be, for example, an image reading apparatus such as a scanner.

What is claimed is:

1. A medium conveyance apparatus comprising:
a conveyance unit configured to convey media;
a detection unit configured to detect the media conveyed by the conveyance unit; and
a control unit configured to determine presence or absence of double feed of the media based on a threshold and a detection result of the detection unit and control driving of the conveyance unit, wherein
the control unit updates the threshold based on the detection result and sets conveyance speed of the media during a conveyance operation in updating the threshold to be lower than conveyance speed of the media during a conveyance operation in not updating the threshold.

2. The medium conveyance apparatus according to claim 1, wherein the control unit updates the threshold during the conveyance operation in continuously conveying the media.

3. The medium conveyance apparatus according to claim 1, further comprising:
a placement unit on which the media are placed; and
a feeding port through which the media placed on the placement unit are fed, wherein
the conveyance unit is configured to feed the media from the feeding port, and
the detection unit is disposed at a position where the detection unit detects the media fed from the feeding port.

4. The medium conveyance apparatus according to claim 3, wherein
the medium conveyance apparatus includes a plurality of the placement units, and
the control unit continuously conveys the media from the placement units different from one another in random order.

5. The medium conveyance apparatus according to claim 4, wherein the control unit updates the threshold to correspond to the respective placement units.

6. The medium conveyance apparatus according to claim 1, further comprising a selection unit configured to select in which of the conveyed media the threshold is updated.

7. A printing apparatus comprising:
the medium conveyance apparatus according to claim 1; and
a printing unit configured to perform printing on the media conveyed by the conveyance unit.

8. The printing apparatus according to claim 7, wherein, when printing is performed on only one print medium among the media, the control unit causes the conveyance unit to convey a medium for threshold update different from the print medium among the media before the printing and updates the threshold.

9. The printing apparatus according to claim 8, further comprising a discharge unit to which the media are discharged, wherein
the printing apparatus includes, as the discharge unit, a first discharge unit to which the print medium is discharged and a second discharge unit to which the medium for threshold update is discharged.

10. A medium conveyance method in a medium conveyance apparatus including: a conveyance unit configured to convey media; and a detection unit configured to detect the media conveyed by the conveyance unit, the medium conveyance apparatus determining presence or absence of double feed of the media based on a threshold and a detection result of the detection unit, the medium conveyance method comprising:
updating the threshold based on the detection result; and
setting conveyance speed of the media during a conveyance operation in updating the threshold to be lower than conveyance speed of the media during a conveyance operation in not updating the threshold.
